(19) United States
(12) Patent Application Publication
(10) Pub. No.: US 2026/0161298 A1
(43) Pub. Date: Jun. 11, 2026

(54) NON-VOLATILE MEMORY CAPABLE OF PERFORMING INTER-MEMORY COMMUNICATION, STORAGE DEVICE INCLUDING THE SAME, AND METHOD THEREOF

(71) Applicant: SAMSUNG ELECTRONICS CO., LTD., Suwon-si (KR)

(72) Inventor: Hyunjoon YOO, Suwon-si (KR)

(73) Assignee: SAMSUNG ELECTRONICS CO., LTD., Suwon-si (KR)

(21) Appl. No.: 19/408,692

(22) Filed: Dec. 4, 2025

(30) Foreign Application Priority Data
Dec. 6, 2024 (KR) 10-2024-0180873

(51) Int. Cl. G06F 3/06

(52) U.S. Cl. CPC G06F 3/0614; G06F 3/0658; G06F 3/0688

(57) ABSTRACT

A storage device includes a plurality of non-volatile memories, and a storage controller connected to the plurality of non-volatile memories through a data line. The plurality of non-volatile memories are connected to each other through an internal clock line separated from the data line and an internal data line synchronized to the internal clock line. Each of the plurality of non-volatile memories transmits an internal data signal including prediction time information of a peak current through the internal data line.

### CROSS-REFERENCE TO RELATED APPLICATIONS

This application claims priority under 35 U.S.C. § 119 to Korean Patent Application No. 10-2024-0180873 filed on Dec. 6, 2024, in the Korean Intellectual Property Office, the disclosures of which are incorporated by reference herein in their entireties.

### BACKGROUND

Embodiments of the present disclosure described herein relate to a non-volatile memory capable of performing inter-memory communication, a storage device including the same, and a method thereof.

A semiconductor memory device may be mainly classified as a volatile memory or a non-volatile memory. Read and write speeds of the volatile memory (e.g., a DRAM or an SRAM) are fast, but the data stored in the volatile memory disappear when a power is turned off. In contrast, the non-volatile memory may retain data stored therein even when a power is turned off. A representative example of the non-volatile memory is a flash memory.

The non-volatile memory may perform various memory access operations (e.g., program, read, and erase operations). Power amounts which are required for respective memory access operations may be different. For example, as the memory access operations require larger power amount than a sequential program operation, a peak current may be generated. Because the event that peak currents are generated concurrently is fatal to an operation of a memory device, there may be a need to predict and manage the peak current.

### SUMMARY

Embodiments of the present disclosure provide a non-volatile memory capable of performing inter-memory communication for sharing prediction time information of a peak current, a storage device including the same, and a method thereof.

According to an embodiment, a storage device includes a plurality of non-volatile memories, and a storage controller connected to the plurality of non-volatile memories through a data line. The plurality of non-volatile memories are connected to each other through an internal clock line separated from the data line and an internal data line synchronized to the internal clock line, and each of the plurality of non-volatile memories transmits an internal data signal including prediction time information of a peak current through the internal data line.

According to an embodiment, a method of a non-volatile memory includes obtaining an internal data signal including prediction time information of a peak current of the non-volatile memory, and transmitting the internal data signal through an internal data line synchronized to an internal clock line.

According to an embodiment, a non-volatile memory includes a memory cell array, an input/output circuit connected to a data line transmitting write data or read data associated with the memory cell array, an internal clock line separated from the data line, and an internal data line synchronized to the internal clock line, and a control logic circuit that transmits an internal data signal including prediction time information of a peak current through the internal data line, based on controlling the input/output circuit.

### BRIEF DESCRIPTION OF THE FIGURES

The above and other objects and features of the present disclosure will become apparent by describing in detail embodiments thereof with reference to the accompanying drawings.

FIG. 1 is a block diagram of a storage device according to some example embodiments.

FIG. 2 is a block diagram of a storage controller of FIG. 1, according to some example embodiments.

FIG. 3 is an example block diagram of a non-volatile memory of FIG. 1, according to some example embodiments.

FIG. 4 is a circuit diagram illustrating an example of a memory block in a memory cell array of FIG. 3, according to some example embodiments.

FIG. 5 illustrates a plurality of non-volatile memories according to some example embodiments.

FIGS. 6 and 7 illustrate an internal data signal according to some example embodiments.

FIG. 8 is a timing diagram of inter-memory communication according to some example embodiments.

FIG. 9 is a timing diagram of inter-memory communication and buffered data when prediction time information of different non-volatile memories overlap each other, according to some example embodiments.

FIG. 10 is a timing diagram of inter-memory communication and buffered data when a header is changed, according to some example embodiments.

FIG. 11 is a timing diagram of inter-memory communication and buffered data when an occurrence prediction time is changed, according to some example embodiments.

FIG. 12 is a timing diagram of a peak current information sharing operation and a program operation of a storage device according to some example embodiments.

FIG. 13 is a timing diagram of an internal clock signal and an internal data signal according to some example embodiments.

FIG. 14 is a flowchart of an operating method of a non-volatile memory according to some example embodiments.

FIG. 15 is a flowchart of an operating method based on a change of prediction time information according to some example embodiments.

FIG. 16 is a flowchart of an internal data signal transmitting method according to some example embodiments.

FIG. 17 is a flowchart of an internal data signal transmitting method according to some example embodiments.

### DETAILED DESCRIPTION

Below, embodiments of the present disclosure will be described in detail and clearly to such an extent that one skilled in the art easily carries out the present disclosure.

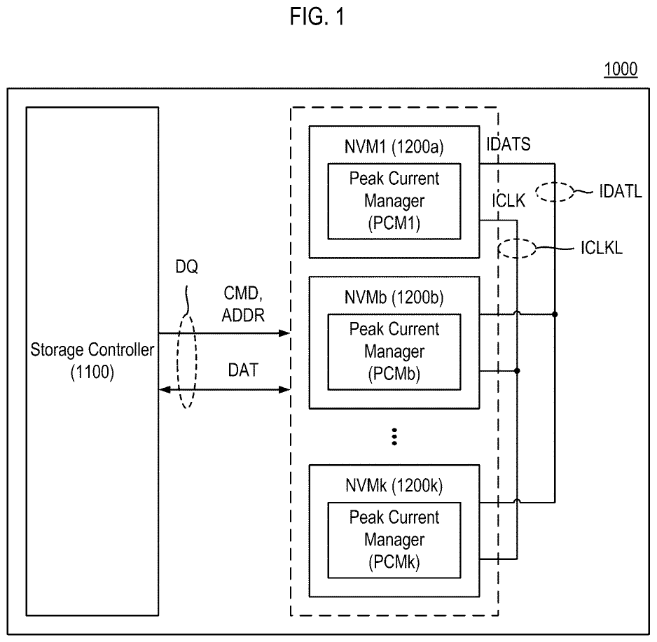

FIG. 1 is a block diagram of a storage device according to some example embodiments.

Referring to FIG. 1, a storage device 1000 according to some example embodiments may include a storage controller 1100 and a plurality of non-volatile memories 1200a to 1200k.

The storage controller 1100 may be configured to control the plurality of non-volatile memories 1200a to 1200k under control of a host or depending on a command of the host. For example, depending on the request of the host, the storage controller 1100 may write data in the plurality of non-volatile memories 1200a to 1200k or may read data stored in the plurality of non-volatile memories 1200a to 1200k. The storage controller 1100 may be connected to the plurality of non-volatile memories 1200a to 1200k through a data line DQ. Through the data line DQ, the storage controller 1100 may transmit a command CMD and an address ADDR to the plurality of non-volatile memories 1200a to 1200k or may exchange data DAT (e.g., program data or read data) with the plurality of non-volatile memories 1200a to 1200k.

The plurality of non-volatile memories 1200a to 1200k may be connected to the storage controller 1100 through the data line DQ. Under control of the storage controller 1100, the plurality of non-volatile memories 1200a to 1200k may store data or may transfer the stored data to the storage controller 1100. For example, the plurality of non-volatile memories 1200a to 1200k may be implemented with a NAND flash memory device, but embodiments of the present disclosure are limited thereto. The plurality of non-volatile memories 1200a to 1200k may include k non-volatile memories (k being a natural number), and each of the non-volatile memories 1200a to 1200k may be implemented with a chip or a die.

In some example embodiments, the plurality of non-volatile memories 1200a to 1200k may be connected to each other through an internal clock line ICLKL separated from the data line DQ and an internal data line IDATL synchronized to the internal clock line ICLKL. In the present disclosure, an operation in which the plurality of non-volatile memories 1200a to 1200k mutually transmit or share signals, information, and data through the internal data line IDATL may be referred to as “inter-memory communication”. The inter-memory communication may be performed independently from the storage controller 1100. According to some example embodiments, the storage controller 1100 may manage a policy, requirements, settings, etc. associated with the inter-memory communication.

The internal clock line ICLKL may be configured to provide an internal clock signal ICLK for synchronization of the internal data line IDATL in the inter-memory communication. According to some example embodiments, one non-volatile memory among the plurality of non-volatile memories 1200a to 1200k may be configured to generate the internal clock signal ICLK. According to some example embodiments, one non-volatile memory defined or set as a master from among the plurality of non-volatile memories 1200a to 1200k may be configured to generate the internal clock signal ICLK. In the present disclosure, a master non-volatile memory may be defined as a non-volatile memory which manages a policy, requirements, settings, etc. associated with the inter-memory communication. The non-volatile memory which generates the internal clock signal ICLK may transmit the internal clock signal ICLK through the internal clock line ICLKL.

An internal data signal IDATS which is transmitted/received through the internal data line IDATL may include information generated or processed from each non-volatile memory. The internal data line IDATL may be implemented for the inter-memory communication independently of the data line DQ connected to the storage controller 1100 described above. The internal data signal IDATS is synchronized to the internal clock signal ICLK.

In some example embodiments, each of the plurality of non-volatile memories 1200a to 1200k may include a peak current manager. That is, the plurality of non-volatile memories 1200a to 1200k may include a plurality of peak current managers PCM1 to PCMk.

The plurality of peak current managers PCM1 to PCMk may be configured to calculate (or predict) a peak current amount in consideration of one or more of 1) individual processing tasks (or threads) for performing various memory access operations (e.g., a read operation, a program operation, and an erase operation) which the storage controller 1100 requires, and 2) the amount of current which the plurality of non-volatile memories 1200a to 1200k use, etc. In some example embodiments, the plurality of peak current managers PCM1 to PCMk may be configured to calculate (or predict) an occurrence prediction time of the peak current in consideration of the processing tasks, the amount of current, etc. described above. Below, for convenience of description, information about the peak current, which includes the peak current amount and the occurrence prediction time, may be referred to as “peak current information”.

The plurality of peak current managers PCM1 to PCMk may generate the internal data signal IDATS (or an internal packet) including the prediction time information of the peak current or the information of the peak current amount obtained through the calculation (or prediction). Herein, the prediction time information may indicate the occurrence prediction time of the peak current or may indicate the number of cycles of the internal clock ICLK, which remain from the transmission time of the internal data signal IDATS to the occurrence prediction time, that is, the number of residual cycles or a residual time.

The internal data signal IDATS may be a digital signal which is obtained by coding the prediction time information or the current amount information.

In some example embodiments, the internal data signal IDATS may include a header and a body subsequent to the header. The header may indicate whether the body includes any information. For example, when the header indicates a first logical level (e.g., logic high or logic low), the body may include the prediction time information. For example, when the header indicates a second logical level (e.g., logic low or logic high), the body may include the current amount information. Accordingly, the plurality of peak current managers PCM1 to PCMk may include peak current-related information, whose type differs depending on a setting of the logical level of the header, in the internal data signal IDATS.

Alternatively, in some example embodiments, the internal data signal IDATS may include only the body except for the header.

The plurality of non-volatile memories 1200a to 1200k may transmit the internal data signal IDATS generated by the plurality of peak current managers PCM1 to PCMk through the internal data line IDATL.

The plurality of peak current managers PCM1 to PCMk may control operations scheduled for the plurality of non-volatile memories 1200a to 1200k based on the internal data signal IDATS. In detail, each peak current manager may receive peak current information from the remaining non-volatile memories through the internal data line IDATL. Each peak current manager may together manage the peak current information included in the internal data signal IDATS received from the remaining non-volatile memories, in addition to the peak current information obtained from the corresponding non-volatile memory.

In some example embodiments, when the peak current amount indicated by the current amount information is greater than or equal to a threshold value, each peak current manager may stop the operation scheduled for each non-volatile memory.

In some example embodiments, each peak current manager may sum peak current amounts which the peak current information under management indicates; when a summed value according to the sum is greater than or equal to the threshold value, each peak current manager may stop the operation scheduled for each non-volatile memory.

In some example embodiments, at the occurrence prediction time of the peak current indicated by the prediction time information, each peak current manager may stop the operation scheduled for each non-volatile memory. That is, when the occurrence of the peak current is predicted from the remaining non-volatile memories, each peak current manager may in advance check the occurrence prediction time of the peak current of the remaining non-volatile memories through the received internal data signal IDATS. At the checked occurrence prediction time (or before the occurrence prediction time), each peak current manager may stop the operation already scheduled for the non-volatile memory such that the excessive use of the power is prevented.

The storage device 1000 according to the above embodiments is capable of sharing the occurrence prediction time of the peak current without limitation on the protocol of the storage device 1000, by using the internal data line IDATL implemented for non-volatile memories independently of the data line DQ connected to the storage controller 1100. Also, each non-volatile memory is capable of coping with the peak current in advance before the peak current is generated.

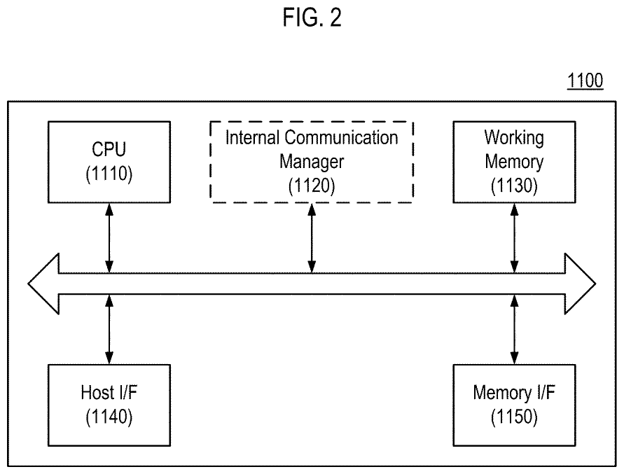

FIG. 2 is a block diagram of a storage controller of FIG. 1, according to some example embodiments.

Referring to FIG. 2, the storage controller 1100 according to some example embodiments may include a central processing unit (CPU) 1110, an internal communication manager 1120, a working memory 1130, a host interface 1140, a memory interface 1150.

The CPU 1110 may drive firmware which is executable in the storage controller 1100. For example, the CPU 1110 may drive various firmware or software loaded to the working memory 1130. Alternatively, the CPU 1110 may execute firmware or software, which takes charge of functions of a storage device, such as a host interface layer (HIL) or a flash interface layer (FIL).

In some example embodiments, when the internal communication manager 1120 is provided as a software module, the CPU 1110 may execute the software module corresponding to the internal communication manager 1120 and may perform operations of the storage controller 1100 of the present disclosure in addition to the operation of managing a policy, requirements, settings, etc. associated with the inter-memory communication.

In some example embodiments, the CPU 1110 may include a plurality of cores. Each of the plurality of cores may be implemented with an independent processor core. The plurality of cores may include a host core, a flash translation layer (FTL) core, and a NAND core.

The host core may be defined as an internal core of a storage device (e.g., 1000 of FIG. 1), which performs an HIL-related operation. For example, the host core may process a request received from the host through the host interface 1140.

The FTL core may be defined as an internal core of the storage device, which performs an FTL-related operation. For example, the FTL core may control the NAND core based on the request received from the host core such that the read operation, the write operation, or the erase operation is performed in the non-volatile memories (e.g., 1200a to 1200k of FIG. 1). Alternatively, by using the FTL, the FTL core may perform an address mapping operation such that a logical block address (LBA) transmitted from the host is mapped to a physical block address (PBA) corresponding to a physical location of a non-volatile memory.

The NAND core may be defined as an internal core of the storage device, which performs an FIL-related operation. For example, under control of the FTL core, the NAND core may control the memory interface 1150 such that operations of the non-volatile memory are performed.

The internal communication manager 1120 may be configured to manage a policy, requirements, settings, etc. associated with the inter-memory communication. In some example embodiments, the internal communication manager 1120 may set a master non-volatile memory of the inter-memory communication. Instead of the storage controller 1100, the master non-volatile memory set through the internal communication manager 1120 may manage a policy, requirements, settings, etc. associated with the inter-memory communication or may generate and transmit an internal clock signal.

In some example embodiments, the internal communication manager 1120 may manage time intervals allocated for transmission of an internal data signal individually for each non-volatile memory. For example, the internal communication manager 1120 may set a magnitude (or a length) of the time interval (e.g., the number of cycles of the internal clock signal allocated to each non-volatile memory), may allocate a specific non-volatile memory every time interval, or may set the order of non-volatile memories to which the time intervals will be allocated.

According to some example embodiments, the internal communication manager 1120 may be omitted. In this case, the storage controller 1100 may not participate in the inter-memory communication, and the operation of the internal communication manager 1120 according to the above embodiments may be performed through only the master non-volatile memory or through a plurality of non-volatile memories.

Data or software (or firmware) for controlling the storage controller 1100 is loaded to the working memory 1130. The software or data loaded to the working memory 1130 are driven or processed by the CPU 1110. A flash translation layer which is driven by the CPU 1110 performs functions such as an address managing function, a garbage collection function, and a wear-leveling function.

The host interface 1140 provides an interface between the host and the storage controller 1100. The host and the storage controller 1100 may be connected through one of various standardized interfaces. Herein, the standardized interfaces include various interfaces such as an advanced technology attachment (ATA) interface, a serial ATA (SATA) interface, an external SATA (e-SATA) interface, a small computer small interface (SCSI), a serial attached SCSI (SAS), a peripheral component interconnection (PCI) interface, a PCI Express (PCI-E) interface, a universal serial bus (USB) interface, an IEEE 1394 interface, a universal flash store (UFS) interface, and a card interface.

The memory interface 1150 provides interfacing between the storage controller 1100 and the non-volatile memory. For example, data processed by the CPU 1110 may be stored in the non-volatile memory through the memory interface 1150, or data read from the non-volatile memory may be transferred to the storage controller 1100 through the memory interface 1150.

In some example embodiments, in addition to the above components, the storage controller 1100 may further include a read only memory (ROM), which stores code data necessary for a booting operation, or an error correction code (ECC) block.

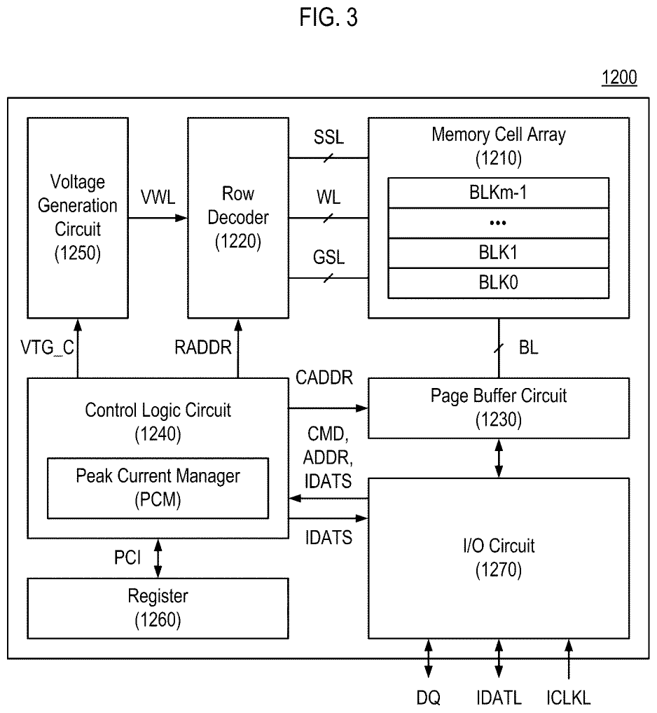

FIG. 3 is an example block diagram of a non-volatile memory of FIG. 1, according to some example embodiments.

Referring to FIG. 3, a non-volatile memory 1200 according to some example embodiments may include a memory cell array 1210, a row decoder 1220, a page buffer circuit 1230, a control logic circuit 1240, a voltage generation circuit 1250, a register 1260, and an input/output circuit 1270. Also, although not illustrated in FIG. 3, the non-volatile memory 1200 may further include components such as column logic, a pre-decoder, a temperature sensor, a command decoder, and an address decoder. Also, the non-volatile memory 1200 may be one of the plurality of non-volatile memories 12001 to 1200k illustrated in FIG. 1.

The memory cell array 1210 may include a plurality of memory blocks BLK0 to BLKm-1 (m being a positive integer). Each of the plurality of memory blocks BLK0 to BLKm-1 may include a plurality of memory cells. Each of the plurality of memory blocks BLK0 to BLKm-1 may be composed of a plurality of pages. Each page may be composed of a plurality of memory cells. Each memory block may correspond to an erase unit, and each page may correspond to a read or program unit. The plurality of memory blocks BLK0 to BLKm-1 may be included in one memory plane, but embodiments of the present disclosure are not limited thereto. The memory cell array 1210 may be connected to the page buffer circuit 1230 through bit lines BL and may be connected to the row decoder 1220 through word lines WL, string selection lines SSL, and ground selection lines GSL.

In some example embodiments, the memory cell array 1210 may include a 3D memory cell array. The 3D memory cell array may be implemented with a plurality of levels and may include word lines or bit lines which are shared between levels.

The row decoder 1220 may select one of the memory blocks BLK0 to BLKm-1 of the memory cell array 1210 in response to a row address RADDR. The row decoder 1220 may select one of word lines of the selected memory block in response to the row address RADDR. The row decoder 1220 transfers a voltage VWL corresponding to an operation mode to the selected word line of the selected memory block. In the program operation, the row decoder 1220 transfers a program voltage and a verify voltage to the selected word line and a pass voltage to the unselected word lines. In the read operation, the row decoder 1220 transfers a read voltage to the selected word line and a read pass voltage to the unselected word lines.

The page buffer circuit 1230 may include a plurality of page buffers. The plurality of page buffers may be respectively connected to memory cells through the bit lines BL. The page buffer circuit 1230 may select at least one of the bit lines BL in response to a column address CADDR provided from the control logic circuit 1240. The page buffer circuit 1230 may operate as a write driver or a sense amplifier depending on an operation mode. For example, in the program operation, the page buffer circuit 1230 may apply a bit line voltage corresponding to data to be programmed to a selected bit line. In the read operation, the page buffer circuit 1230 may read data stored in a memory cell by sensing a current or a voltage of the selected bit line.

The control logic circuit 1240 may control various kinds of operations of the non-volatile memory 1200. The control logic circuit 1240 may output various kinds of control signals for programming data in the memory cell array 1210, reading data from the memory cell array 1210, or erasing data stored in the memory cell array 1210 in response to the command CMD and/or the address ADDR. For example, the control logic circuit 1240 may output a voltage control signal VTG_C, the row address RADDR, the column address CDDR, etc.

The control logic circuit 1240 may include individual processing tasks (or threads) for performing various memory access operations (e.g., a read operation, a program operation, and an erase operation). The processing tasks may be defined based on various memory units (e.g., a die, a block, a plane, and a page). Because power consumption amounts of the processing tasks are capable of being identical or different, there may be a need to manage the power of the plurality of non-volatile memories 1200 in an individual or multiple manner. For example, in the case of the sequential program operation, because a task for multiple memory units is frequently used, the probability that a large peak current is generated is high.

In some example embodiments, the control logic circuit 1240 may include a peak current manager PCM. The peak current manager PCM may perform the above operations described with reference to FIG. 1. In some example embodiments, the peak current manager PCM may obtain prediction time information and/or current amount information of the peak current and may generate the internal data signal IDATS including the prediction time information or the current amount information. The peak current manager PCM may generate peak current information PCI including the prediction time information and/or the current amount information and may buffer or store the generated peak current information PCI in the register 1260. Alternatively, the peak current manager PCM may program the peak current information PCI in the memory cell array 1210.

In some example embodiments, the peak current manager PCM may include a prediction time counter configured to calculate a prediction time which the prediction time information of the peak current indicates.

In some example embodiments, the control logic circuit 1240 may buffer the peak current information PCI in the register 1260 before at least one cycle from the time interval allocated for the transmission of the peak current information PCI.

In some example embodiments, when the buffered prediction time information is changed, the peak current manager PCM may buffer the changed prediction time information in the register 1260.

Alternatively, the peak current manager PCM may generate the internal data signal IDATS including the peak current information PCI and may provide the generated internal data signal IDATS to the input/output circuit 1270. In some example embodiments, the peak current manager PCM may provide the internal data signal IDATS to the input/output circuit 1270 for each time interval allocated to the non-volatile memory 1200. Accordingly, the input/output circuit 1270 may transmit the internal data signal IDATS to the remaining non-volatile memories every allocated time interval.

In some example embodiments, the peak current manager PCM may control an operation scheduled for the non-volatile memory 1200, based on the internal data signals IDATS received from the remaining non-volatile memories. For example, when the scheduled operation is the program operation and the current amount information indicated by the internal data signal IDATS is greater than or equal to the threshold value, the peak current manager PCM may stop generating or providing the voltage control signal VTG_C corresponding to the program voltage or may stop generating or providing the row address RADDR and/or the column address CADDR.

Alternatively, when the scheduled operation is the program operation and the prediction time information indicated by the internal data signal IDATS indicates that a prediction time arrives or is imminent, the peak current manager PCM may stop generating or providing the voltage control signal VTG_C corresponding to the program voltage or may stop generating or providing the row address RADDR and/or the column address CADDR.

In some example embodiments, based on controlling the input/output circuit 1270, the control logic circuit 1240 may receive the internal data signals IDATS from the remaining non-volatile memories through the internal data line IDATL or may transmit the generated internal data signal IDATS to the remaining non-volatile memories through the internal data line IDATL.

The voltage generation circuit 1250 may generate various kinds of voltages for performing the program, read, and erase operations based on the voltage control signal VTG_C. For example, the voltage generation circuit 1250 may generate a program voltage, a read voltage, and a program verify voltage, etc. as the word line voltage VWL. For example, the program voltage may be generated in an incremental step pulse program (ISPP) manner.

The register 1260 may store the peak current information PCI generated or obtained according to the above embodiments. In this case, the peak current information PCI may be associated with the non-volatile memory 1200 or may be associated with the remaining non-volatile memories. Alternatively, when the prediction time information is coded, the register 1260 may store the occurrence prediction time or the number of residual cycles mapped to the coded bit. Alternatively, when the current amount information is coded, the register 1260 may store a current amount mapped to the coded bit. For example, the register 1260 may store a mapping table defining a mapping relationship between the coded bit and the occurrence prediction time, the number of residual cycles, or the current amount.

The input/output circuit 1270 may be configured to receive the command CMD, the address ADDR, data, etc. provided from a storage controller. The command CMD and the address ADDR received through the input/output circuit 1270 may be provided to the control logic circuit 1240.

In some example embodiments, the input/output circuit 1270 may be connected to the internal data line IDATL and the internal clock line ICLKL separated from the data line DQ. The input/output circuit 1270 may receive an internal clock signal through the internal clock line ICLKL and may transmit or receive the internal data signal IDATS through the internal data line IDATL in synchronization with the internal clock signal. The input/output circuit 1270 may be provided from the internal data signal IDATS from the control logic circuit 1240 or may transfer the internal data signals IDATS received from the remaining non-volatile memories to the control logic circuit 1240.

Also, the input/output circuit 1270 may be connected to the data line DQ, and the input/output circuit 1270 may receive the write data to be written in the memory cell array 1210 through the data line DQ or may transmit the read data read from the memory cell array 1210 through the data line DQ. For example, the input/output circuit 1270 may transfer program data received through the data line DQ to the page buffer circuit 1230 or may transmit data read through the page buffer circuit 1230 to the outside (e.g., a storage controller).

The non-volatile memory 1200 according to the above embodiments may share the prediction time information with the remaining non-volatile memories through the internal data line IDATL.

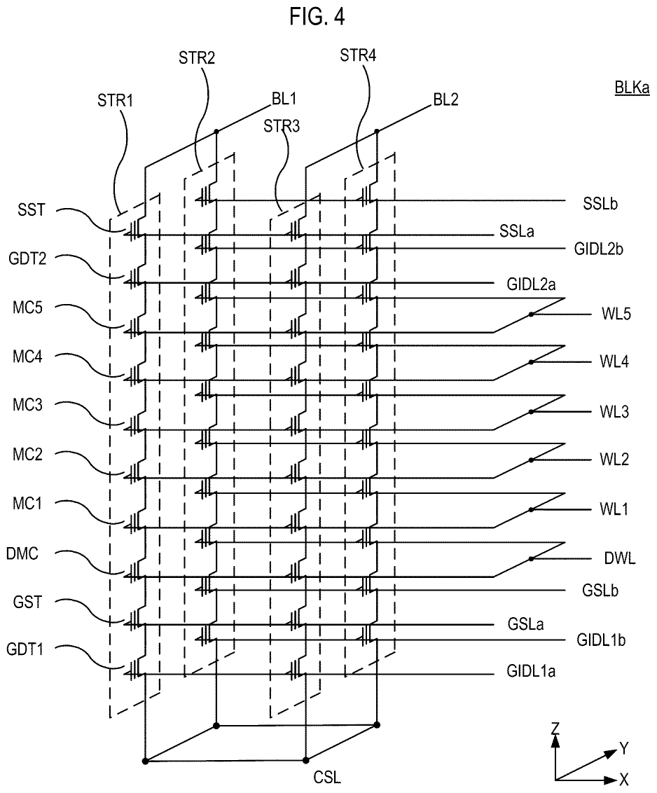

FIG. 4 is a circuit diagram illustrating an example of a memory block in a memory cell array of FIG. 3, according to some example embodiments. For convenience of description, it is assumed that four strings STR1 to STR4 are included in one memory block.

Referring to FIG. 4, a memory block BLKa may include the plurality of strings STR1 to STR4 vertically stacked on a substrate. The plurality of strings STR1 to STR4 may be arranged in a first direction (i.e., an X-axis direction) and a second direction (i.e., a Y-axis direction).

Strings located at the same column from among the plurality of strings STR1 to STR4 may be connected to the same bit line. For example, the first and second strings STR1 and STR2 may be connected to a first bit line BL1, and the third and fourth strings STR3 and STR4 may be connected to a second bit line BL2.

Each of the plurality of strings STR1 to STR4 may include a plurality of cell transistors. Each of the plurality of cell transistors may include a charge trap flash (CTF) memory cell, but embodiments of the present disclosure are not limited thereto. The plurality of cell transistors may be stacked in a third direction (i.e., a Z-axis direction).

The plurality of strings STR1 to STR4 may be connected in common to a common source line CSL. For example, as illustrated in FIG. 4, the common source line CSL may be connected in common to lower ends of the plurality of strings STR1 to STR4. However, this is provided as an example. It is sufficient if the common source line CSL is electrically connected to the lower ends of the strings STR1 to STR4, and the present disclosure is not limited to the case that the common source line CSL is physically located at the lower ends of the strings STR1 to STR4. Below, for convenience of description, a structure and a configuration of a string will be described based on the first string STR1. The remaining strings STR2, STR3, and STR4 may be similar in structure to the first string STR1, and thus, additional description will be omitted to avoid redundancy.

The plurality of cell transistors may be connected in series between the first bit line BL1 and the common source line CSL. For example, the plurality of cell transistors may include GIDL transistors GDT1 and GDT2, a string selection transistor SST, memory cells MC1 to MC5, a dummy memory cell DMC, and a ground selection transistor GST.

The first GIDL transistor GDT1 may be disposed at the lowermost end of the string STR1. For example, the first GIDL transistor GDT1 may be connected to the common source line CSL at the lower end of the string STR1. However, this is provided as an example, and embodiments of the present disclosure are not limited thereto. A gate of the first GIDL transistor GDT1 may be connected to a first GIDL line GIDL1a.

The second GIDL transistor GDT2 may be disposed at an upper end of the string STR1, in detail, may be disposed between the string selection transistor SST and the memory cell MC5. That is, the second GIDL transistor GDT2 may be connected to the first bit line BL1 through the string selection transistor SST. A gate of the first GIDL transistor GDT1 may be connected to a first GIDL line GIDL1a.

The GIDL transistors GDT1 and GDT2 are illustrated in FIG. 4 as being provided at the upper end and the lower end of the string STR1. However, this is provided as an example. According to an embodiment, the GIDL transistor may be provided only at the upper end of the string STR1, or the GIDL transistor may be provided only at the lower end of the string STR1.

A string selection transistor SST may be disposed at the uppermost end of the string STR. The string selection transistor SST may be connected to the first bit line BL1 at the upper end of the string STR1. A gate of the string selection transistor SST may be connected to a string selection line SSLa. However, this is provided as an example. According to an embodiment, a plurality of string selection transistors which are connected in series may be provided between the first bit line BL1 and the second GIDL transistor GDT2.

Aground selection transistor GST may be provided between the dummy memory cell DMC and the first GIDL transistor GDT1. A gate of the ground selection transistor GST may be connected to a ground selection line GSLa. However, this is provided as an example. According to an embodiment, a plurality of ground selection transistors which are connected in series may be provided between the dummy memory cell DMC and the first GIDL transistor GDT1.

The first to fifth memory cells MC1 to MC5 may be connected in series between the string selection transistor SST and the dummy memory cell DMC. Gates of the first to fifth memory cells MC1 to MC5 may be respectively connected to first to fifth word lines WL1 to WL5.

A dummy memory cell DMC may be provided between the first memory cell MC1 and the first GIDL transistor GDT1. A gate of the dummy memory cell DMC may be connected to a dummy word line DWL. However, this is provided as an example. According to an embodiment, a plurality of dummy memory cells which are connected in series may be provided between the first memory cell MC1 and the first GIDL transistor GDT1. Alternatively, an additional dummy memory cell may be provided between the string selection transistor SST and the fifth memory cell MC5. Alternatively, an additional dummy memory cell may be provided between the memory cells MC1 to MC5. Alternatively, the dummy memory cell DMC may not be provided.

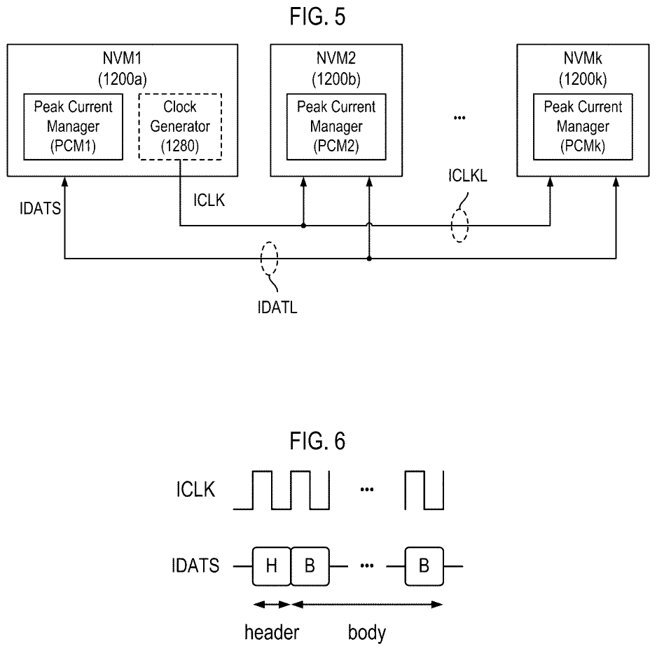

FIG. 5 illustrates a plurality of non-volatile memories according to some example embodiments.

Referring to FIG. 5, the plurality of non-volatile memories 1200a to 1200k include the plurality of peak current managers PCM1 to PCMk. The plurality of non-volatile memories 1200a to 1200k may perform the following operations through the plurality of peak current managers PCM1 to PCMk: an operation of generating and sharing the internal data signal IDATS according to the above embodiments and a stop operation according to the peak current information. In particular, the internal data signal IDATS may include the prediction time information, and non-volatile memories receiving the corresponding internal data signal IDATS may in advance check the occurrence prediction time of the peak current through the internal data signal IDATS and may cope with the occurrence of the peak current.

The plurality of non-volatile memories 1200a to 1200k may be connected through the internal data line IDATL and the internal clock line ICLKL and may share the internal data signal IDATS with each other through the internal data line IDATL.

In some example embodiments, one non-volatile memory (or one or more non-volatile memories) among the plurality of non-volatile memories 1200a to 1200k may further include a clock generator 1280 configured to generate the internal clock signal ICLK for the plurality of non-volatile memories 1200a to 1200k. The clock generator 1280 may generate the internal clock signal ICLK for the inter-memory communication according to the above embodiments. In other words, the internal clock ICLK generated from the clock generator 1280 is used only for the inter-memory communication separately from a clock signal capable of being provided from a storage controller. One non-volatile memory (or one or more non-volatile memories) may transmit the generated internal clock signal ICLK through the internal clock line ICLKL.

In some example embodiments, the plurality of peak current managers PCM1 to PCMk included in the plurality of non-volatile memories 1200a to 1200k may be disabled when a peak current is not predicted within a preset or predefined prediction window. Alternatively, when the peak current is not predicted within the preset or predefined prediction window after one or more non-volatile memories share the internal data signal IDATS, the plurality of peak current managers PCM1 to PCMk may be disabled (or may enter a sleep (or idle) mode). The plurality of peak current managers PCM1 to PCMk may be again enabled after the prediction window passes.

In some example embodiments, based on that the peak current manager is disabled and/or that the peak current is not predicted within the preset or predefined prediction window, the clock generator 1280 may stop generating the internal clock signal ICLK or may output the internal clock signal ICLK indicating a specific logical level (e.g., logic low) or a high-impedance (Hi-Z) state. For example, the operation in which the clock generator 1280 generates the internal clock signal ICLK or stops generating the internal clock signal ICLK may be controlled based on a control logic circuit (e.g., refer to FIG. 3). The control logic circuit may control the clock generator 1280 not to generate the internal clock signal ICLK, based on that the peak current is not predicted within the preset or predefined prediction window.

In some example embodiments, the plurality of peak current managers PCM1 to PCMk may be enabled or disabled based on a ready/busy signal (not illustrated) indicating an operation state of a non-volatile memory. That is, the plurality of peak current managers PCM1 to PCMk may be enabled only in process of the memory access operation and may be disabled in the remaining states.

According to the above embodiments, when the plurality of peak current managers PCM1 to PCMk are disabled, the internal clock signal ICLK may indicate the specific logical level (e.g., logic low) or the high-impedance (Hi-Z) state without toggling.

According to the above embodiments, the plurality of non-volatile memories 1200a to 1200k may be capable of internally generating the internal clock signal ICLK for the inter-memory communication, and when the prediction of the peak current is not required, the plurality of peak current managers PCM1 to PCMk may be disabled, and thus, power consumption may be reduced.

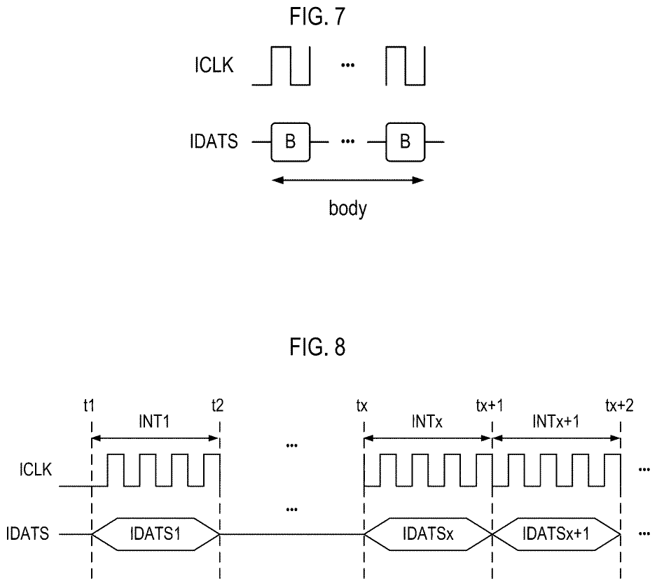

FIGS. 6 and 7 illustrate an internal data signal according to some example embodiments.

First, referring to FIG. 6, the internal data signal IDATS according to some example embodiments may include a header and a body. The header may indicate information which the body following the header includes. For example, the size of the header may be one bit and may correspond to one period of the internal clock signal ICLK. Alternatively, unlike the illustrated example, the size of the header may be two or more bits.

The size of the body may be a plurality of bits and may be differently set depending on the size of information to be shared through the body. Like the header, one bit of the header may correspond to one clock of the internal clock signal ICLK. The body may include prediction time information, a predefined specific time interval, or current amount information depending on a logical level of the header. The prediction time information, the specific time interval, or the current amount information indicated by the plurality of bits included in the body may be stored in the mapping table. A non-volatile memory may obtain the information indicated by the body based on the mapping table.

Next, referring to FIG. 7, the internal data signal IDATS according to some example embodiments may include only a body. The body may include the prediction time information or the current amount information. According to various embodiments, information which the body includes may be indicated. For example, when the body includes the first number of bits, the body may include the prediction time information. Alternatively, when the body includes the second number of bits, the body may include the current amount information. For example, the non-volatile memory may in advance transmit a separate signal (or packet) indicating a type of information to be shared through an internal data line.

FIG. 8 is a timing diagram of inter-memory communication according to some example embodiments. Below, a time point “tx” (x being a natural number) is defined as indicating an arbitrary time point only in each drawing, it is reasonable that arbitrary time points are identical to each other or different from each other.

Referring to FIG. 8, the internal clock signal ICLK for the inter-memory communication toggles, and the internal data signal IDATS is synchronized to the internal clock signal ICLK. A plurality of non-volatile memories may mutually share the internal data signal IDATS including the prediction time information or the current amount information of the peak current through the inter-memory communication. The internal data signal IDATS may be implemented according to the above embodiments (e.g., refer to FIGS. 6 and 7).

A non-volatile memory among the plurality of non-volatile memories transmits the internal data signal IDATS to the remaining non-volatile memories in time intervals individually allocated to the non-volatile memory. Each time interval may have a plurality of clocks of the internal clock signal ICLK depending on the size of the internal data signal IDATS. The clocks of the internal clock signal ICLK, which belong to one time interval, may correspond to one cycle. In the case of FIG. 8, one cycle has four clocks, but embodiments of the present disclosure are not limited thereto

In some example embodiments, a time interval allocated to each non-volatile memory may be repeated every given number of cycles, denoted as “x” (x being a natural number of 2 or more). For example, when first to x-th non-volatile memories perform the inter-memory communication, the first non-volatile memory may transmit a first internal data signal IDATS1 in a first time interval INT1 defined as a time interval from t1 to t2 and may transmit a (x+1)-th internal data signal IDATSx+1 in a (x+1)-th time interval INTx+1 defined as a time interval from tx+1 to tx+2. The x-th non-volatile memory may transmit an x-th internal data signal IDATSx in an x-th time interval INTx defined as a time interval from tx to tx+1. Also, the first to x-th non-volatile memories may transmit the internal data signals IDATS sequentially during the first to x-th time intervals INT1 to INTx.

In some example embodiment, each internal data signal IDATS transmitted in each time interval includes the prediction time information or the current amount information of the peak current of each of the non-volatile memories to which the time intervals are respectively allocated.

Alternatively, in some example embodiments, when cycles pass as much as the given number “x”, non-volatile memories which will be respectively allocated to the time intervals may be changed.

Below, timing diagrams of the inter-memory communication according to various embodiments of the present disclosure will be described. As a non-limiting example, the timing diagrams will be described along with the following details for convenience of description:
Each of first to fourth non-volatile memories transmits the internal data signal in a time interval allocated thereto, and the time interval is repeated per four cycles.

“BUFx” means the peak current information buffered in each non-volatile memory (e.g., the peak current information buffered in the register of FIG. 3 described above).

Information which the internal data signal and the buffered peak current information indicate includes a 1-bit header and a 3-bit body.
Logic low of the header indicates that the body includes the prediction time information, and logic high of the header indicates that the body includes the current amount information.
The prediction time information indicates the number of residual cycles.
The case where the 3-bit body is “000” indicates that information is null, the case where the 3-bit body is “001” indicates that the occurrence prediction time arrives after one cycle, and the case where the 3-bit body is “111” indicates that the occurrence prediction time arrives after seven cycles. “010” to “110” sequentially correspond to two cycles to six cycles.

However, embodiments of the present disclosure are not limited to the above details. That is, the number of non-volatile memories, the number of cycles in which the transmission of the internal data signal is repeated, a bit size of the header and/or the body, information indicated by a logical level of the header, information indicated by the prediction time information, etc. may be variously defined without limitation to the above details.

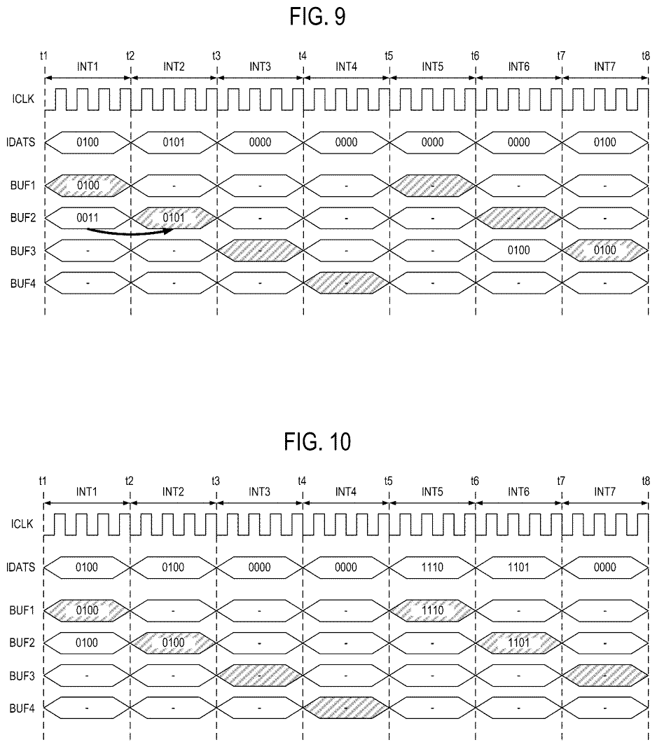

FIG. 9 is a timing diagram of inter-memory communication and buffered data when prediction time information of different non-volatile memories overlap each other, according to some example embodiments.

Referring to FIG. 9, first to fourth buffered data of the first to fourth non-volatile memories are defined. For example, the internal data signal IDATS is a 4-bit signal, the buffered data are 4-bit data, the first bit corresponds to the header, and the remaining bit(s) corresponds to the body. Each internal data signal IDATS and the buffered data include the prediction time information or the current amount information calculated (or predicted) through each non-volatile memory. When the first to fourth non-volatile memories obtain the prediction time information or the current amount information, the first to fourth non-volatile memories may buffer the obtained information.

Time intervals from t1 to t8 may be defined as first to seventh time intervals INT1 to INT7. Time intervals are respectively allocated to non-volatile memories.

In the first time interval INT1, the first buffered data BUF1 corresponding to “0100” are transmitted as the internal data signal IDATS. That is, the first non-volatile memory shares that the occurrence of the peak current is predicted in the fifth time interval INT5 after four cycles from the first time interval INT1 corresponding to a transmission time point. The second buffered data BUF2 corresponding to “0011” in the first time interval INT1 indicates that the occurrence of the peak current is predicted in the fifth time interval INT5 after three cycles from the second time interval INT2 corresponding to a transmission time point of the second non-volatile memory. In other words, the occurrence prediction times of the first and second non-volatile memories overlap each other.

The second non-volatile memory may receive the internal data signal IDATS from the first non-volatile memory in the first time interval INT1 and may check that the occurrence prediction times overlap each other through the received internal data signal IDATS. When the prediction time information of the first non-volatile memory included in the internal data signal IDATS overlaps the buffered prediction time information, the second non-volatile memory may change the buffered prediction time information. In other words, when the prediction time information of different non-volatile memories overlap each other, a non-volatile memory which will transmit the prediction time information to be later than a non-volatile memory first transmitting the prediction time information changes and transmits the prediction time information.

In the case of FIG. 9, the second non-volatile memory changes the buffered data from “0011” to “0101”. Herein, the buffered data “0101” may correspond to a time interval different from the fifth time interval INT5 when the number of residual cycles is reversely calculated as the changed prediction time information.

Also, the non-volatile memory which changes the prediction time information may delay the occurrence of the peak current by stopping or postponing the scheduled operation based on the changed prediction time information.

During the third to sixth time intervals INT3 to INT6, because the third and fourth buffered data BUF3 and BUF4 indicate that information is null, the internal data signal IDATS of “0000” is output. In particular, the fifth time interval INT5 is the occurrence prediction time which the internal data signal IDATS shared in the first time interval INT1 indicates. Accordingly, in the fifth time interval INT5 or a time interval before the fifth time interval INT5, the second to fourth non-volatile memories except for the first non-volatile memory may stop the scheduled operations.

In the sixth time interval INT6, the third buffered data BUF3 indicate “0100”. That is, the occurrence of the peak current may be predicted from the third non-volatile memory. Accordingly, in the seventh time interval INT7, the third non-volatile memory may transmit the internal data signal IDATS including “0100”.

According to the above embodiments, a non-volatile memory may prevent the peak current from being excessively generated by changing the prediction time information when pieces of prediction time information overlap each other.

FIG. 10 is a timing diagram of inter-memory communication and buffered data when a header is changed, according to some example embodiments.

Referring to FIG. 10, a non-volatile memory according to some example embodiments may transmit the prediction time information and may then transmit the current amount information instead of the prediction time information.

For example, in the first time interval INT1, the first non-volatile memory transmits the first buffered data BUF1 corresponding to “0100” as the internal data signal IDATS without modification. That is, after four cycles from the first time interval INT1, that is, in the fifth time interval INT5, the prediction indicating that the peak current is generated in the first non-volatile memory is shared by the remaining non-volatile memories.

In the second time interval INT2, the second non-volatile memory transmits the second buffered data BUF2 corresponding to “0100” as the internal data signal IDATS. That is, after four cycles from the second time interval INT2 corresponding to the transmission time point of the second non-volatile memory, that is, in the sixth time interval INT6, the prediction indicating that the peak current is generated in the second non-volatile memory is shared by the remaining non-volatile memories.

During the third and fourth time intervals INT3 and INT4, because the third and fourth buffered data BUF3 and BUF4 indicate that information is null, the internal data signal IDATS of “0000” is output.

The fifth time interval INT5 is the occurrence prediction time of the peak current of the first non-volatile memory shared in the first time interval INT1. In this case, “1110” output by using the internal data signal IDATS may be buffered in the fifth time interval INT5 or may be buffered in advance before one cycle from the fifth time interval INT5 unlike the illustrated example.

According to some example embodiments, a non-volatile memory may transmit the internal data signal IDATS including the current amount information in an arbitrary time interval after the first time interval INT1 in which the prediction time information is transmitted. According to embodiments, the arbitrary time interval may correspond to the occurrence prediction time shared in the first time interval INT1 or may be a time interval between the first time interval INT1 and the occurrence prediction time. That is, after the non-volatile memory transmits the prediction time information, the non-volatile memory may transmit the current amount information indicating the amount of peak current to be generated at the occurrence prediction time.

For example, in the case of FIG. 10, after the first time interval INT1, in the fifth time interval INT5, the first non-volatile memory again transmits the internal data signal IDATS. In this case, the first non-volatile memory may transmit the internal data signal IDATS having the header of logic high. “110” corresponding to the body is the current amount information indicating the peak current amount. Through the internal data signal IDATS, the remaining non-volatile memories may check how much the peak current amount is in the fifth time interval INT5.

Alternatively, unlike the illustrated example, when a time interval additionally exists between a time interval in which the prediction time information is transmitted and the occurrence prediction time, the first non-volatile memory may transmit the internal data signal IDATS including the current amount information in the corresponding time interval. In this case, the remaining non-volatile memories may in advance check the peak current amount before the occurrence prediction time.

The sixth time interval INT6 is the occurrence prediction time of the peak current of the second non-volatile memory shared in the second time interval INT2. Like the first non-volatile memory, the second non-volatile memory may also transmit “1101” including the current amount information as the internal data signal IDATS in the sixth time interval INT6.

Afterwards, in the seventh time interval INT7, because the occurrence prediction time does not exist, the internal data signal IDATS of “0000” may be again output.

According to the above embodiments, a non-volatile memory is capable of additionally sharing the amount of peak current to be generated at the corresponding occurrence prediction time after transmitting the prediction time information.

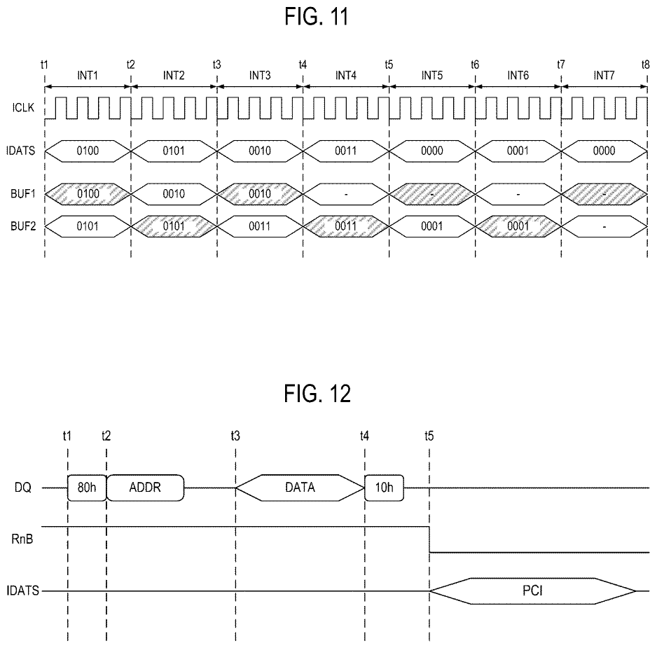

FIG. 11 is a timing diagram of inter-memory communication and buffered data when an occurrence prediction time is changed, according to some example embodiments. In the case of FIG. 11, the following detail among the above details is changed, for example, to:
Each of the first and second non-volatile memories transmits the internal data signal IDATS in a time interval allocated thereto, and the time interval is repeated per two cycles.

Referring to FIG. 11, when the prediction time information is changed after the internal data signal IDATS is transmitted in the first time interval INT1, a non-volatile memory according to some example embodiments may transmit the internal data signal IDATS including the changed prediction time information in an arbitrary time interval after the first time interval INT1. That is, before the occurrence prediction time indicated by the prediction time information arrives, the non-volatile memory may continuously share the changed prediction time information with the remaining non-volatile memories.

According to embodiments, when a prediction time of the prediction time information corresponds to the occurrence prediction time, the occurrence prediction time itself may be changed depending on the prediction of the above peak current manager (e.g., refer to FIGS. 1, 3, and 5) after the internal data signal IDATS is transmitted. In this case, the non-volatile memory may again share the prediction time information indicating the changed occurrence prediction time.

According to embodiments, when the prediction time information is the number of residual cycles, the prediction time information may be changed whenever the time interval allocated to the non-volatile memory for the transmission of the internal data signal IDATS arrives. In this case, the non-volatile memory may again share the prediction time information indicating the changed number of residual cycles.

For example, in the case of FIG. 11, in the first time interval INT1, the first buffered data BUF1 corresponding to “0100” are output as the internal data signal IDATS. When the second non-volatile memory predicts a time interval after five cycles from the second time interval INT2 allocated to the second non-volatile memory as the occurrence prediction time, the second buffered data BUF2 corresponds to “0101”.

After the first non-volatile memory transmits the internal data signal IDATS of “0100”, in the second time interval INT2, the first buffered data BUF1 are changed to “0010” (because the number of residual cycles is 2 based on the third time interval INT3 being a next time interval of the first non-volatile memory). Also, the internal data signal IDATS of “0101” is output as the second buffered data BUF2.

In the third time period INT3, the internal data signal IDATS of “0010” is output as the first buffered data BUF1. After the second non-volatile memory transmits the internal data signal IDATS of “0101”, in the third time interval INT3, the second buffered data BUF2 are changed to “0011” (because the number of residual cycles is 3 based on the fourth time interval INT4 being a next time interval of the second non-volatile memory).

In the fourth time period INT4, the internal data signal IDATS of “0011” is output as the second buffered data BUF2.

In the fifth time interval INT5, the second buffered data BUF2 are changed to “0001”. Also, in the fifth time interval INT5, because there is no prediction time information to be shared, the internal data signal IDATS of “0000” is output. Because the peak current of the first non-volatile memory is capable of being generated in the fifth time interval INT5, according to embodiments, the second non-volatile memory may stop the scheduled operation in the fifth time interval INT5.

In the sixth time period INT6, the internal data signal IDATS of “0001” is output as the second buffered data BUF2. Because the peak current of the second non-volatile memory is capable of being generated in the seventh time interval INT7, according to embodiments, the first non-volatile memory may stop the scheduled operation in the seventh time interval INT7.

According to the above embodiments, a non-volatile memory may allow the remaining non-volatile memories to cope with the variability in predictions by sharing variable prediction time information.

FIG. 12 is a timing diagram of a peak current information sharing operation and a program operation of a storage device according to some example embodiments.

Referring to FIG. 12, at a time point t1, a storage controller transmits a write command 80h through the data line DQ. The write command 80h indicates a data program operation. A column address and a row address may be provided through an address cycle ADDR starting at a time point t2.

During a time interval from t3 to t4, the program data “DATA” are provided from the storage controller through the data line DQ.

A second code 10h of the write command set is provided to the non-volatile memory at a time point t4, and a ready/busy signal RnB transitions to the low level at a time point t5. At the same time, the inter-memory communication may be initiated from the time point t5. Non-volatile memories may share the peak current information PCI with each other through the internal data line IDATL. The peak current information PCI may include the prediction time information or the current amount information.

In some example embodiments, the peak current manager (e.g., refer to FIGS. 1, 3, and 5) according to the above embodiments may be enabled or disabled based on the logical level of the ready/busy signal RnB. For example, when the ready/busy signal RnB transitions from logic low to logic high, the peak current manager may be disabled. Alternatively, when the ready/busy signal RnB transitions from logic high to logic low, the peak current manager may be enabled.

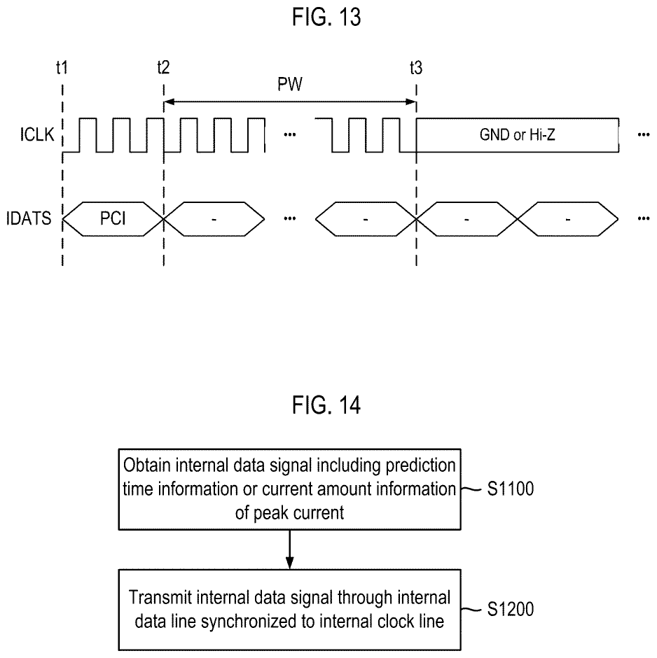

FIG. 13 is a timing diagram of an internal clock signal and an internal data signal according to some example embodiments.

Referring to FIG. 13, the internal clock signal ICLK toggles from a time point t1, and the internal data signal IDATS outputs the peak current information PCI (e.g., the prediction time information or the current amount information) in a time interval from t1 to t2.

Because there is no prediction of the peak current in non-volatile memories from the time point t2, the internal data signal IDATS output a default value or an initial value (e.g., in which all bits are logic low). When the time interval in which the internal data signal IDATS outputs the default value is continuously maintained as much as a preset or predefined prediction window PW, the peak current manager may be disabled. That is, after a time point t3, the peak current manager is disabled, and the internal data signal IDATS continuously outputs the default value.

According to some example embodiments, the internal clock signal ICLK may not toggle any more together with the disable of the peak current manager. That is, the internal clock signal ICLK may output logic low corresponding to a ground GND or may be set to the high-impedance state Hi-Z.

Afterwards, according to the above embodiments, when the ready/busy signal (e.g., refer to FIG. 12) transitions from logic high to logic low, the peak current manager may be again enabled. Also, the internal clock signal ICLK may again toggle.

According to the above embodiments, a non-volatile memory may disable the internal clock signal ICLK and the peak current manager when the occurrence of the peak current is not predicted during a given time, and thus, power consumption may be reduced.

FIG. 14 is a flowchart of an operating method of a non-volatile memory according to some example embodiments.

Referring to FIG. 14, in operation S1100, a non-volatile memory may obtain an internal data signal including the prediction time information of the peak current or the current amount information of the peak current. For example, operation S1100 may be repeatedly performed after the memory access operation on the non-volatile memory is initiated. Alternatively, operation S1100 may be repeatedly performed until the ready/busy signal again transitions to logic high after the ready/busy signal transitions to logic low.

In operation S1200, the non-volatile memory may transmit the internal data signal obtained in operation S1100 through an internal data line synchronized to an internal clock line. Operation S1200 may be repeatedly performed in time intervals individually allocated to the non-volatile memory.

Through the method according to the above embodiments, each non-volatile memory may be in advance provided with the peak current information shared before the occurrence of the peak current and thus is capable of coping with the peak current in advance.

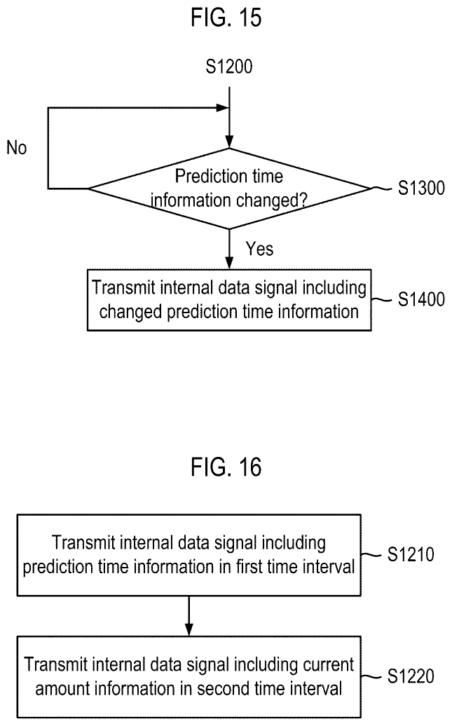

FIG. 15 is a flowchart of an operating method based on a change of prediction time information according to some example embodiments.

Referring to FIG. 15, after operation S1200 in which the internal data signal is transmitted, in operation S1300, the non-volatile memory may check whether the prediction time information is changed. That is, the non-volatile memory may share a specific occurrence prediction time or a specific residual cycle(s) with the remaining non-volatile memories and may then continuously check whether the shared prediction time information is changed. For example, when a predicted value is different from that at the first sharing time, the prediction time information may be changed. When the prediction time information is not changed, operation S1300 may be repeatedly performed.

When the prediction time information is changed in operation S1300, in operation S1400, the non-volatile memory may transmit the internal data signal including the changed prediction time information. Accordingly, the remaining non-volatile memories may be newly provided with the changed prediction time information thus shared.

FIG. 16 is a flowchart of an internal data signal transmitting method according to some example embodiments.

Referring to FIG. 16, in operation S1210, a non-volatile memory may transmit an internal data signal including the prediction time information in a first time interval among allocated time intervals.

In operation S1220, the non-volatile memory may transmit the internal data signal including the current amount information, in a second time interval following the first time interval from among the allocated time intervals. In some example embodiments, operation S1220 may be performed at the occurrence prediction time, which the prediction time information transmitted in operation S1210 indicates, or before the occurrence prediction time. Accordingly, the remaining non-volatile memories provided with the current amount information thus shared are capable of checking the peak current.

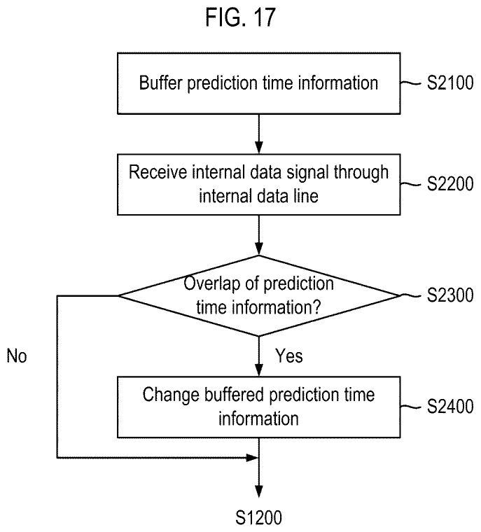

FIG. 17 is a flowchart of an internal data signal transmitting method according to some example embodiments.

Referring to FIG. 17, in operation S2100, a non-volatile memory may buffer the prediction time information. For example, the non-volatile memory may perform buffering on the register (e.g., refer to FIG. 3) according to the above embodiments.

In operation S2200, the non-volatile memory may receive an internal data signal through the internal data line.

In operation S2300, the non-volatile memory may check the prediction time information included in the internal data signal received in operation S2200 overlaps the buffered prediction time information.

When it is checked in operation S2300 that the prediction time information and the buffered prediction time information overlap each other, the non-volatile memory may change the buffered prediction time information. Afterwards, the non-volatile memory may transmit the internal data signal including the changed prediction time information through operation S1200. Alternatively, when it is checked in operation S2300 that the prediction time information and the buffered prediction time information do not overlap each other, the buffered prediction time information may be transmitted through operation S1200 without modification.

According to the present disclosure, a non-volatile memory capable of performing inter-memory communication for sharing prediction time information of a peak current, a storage device including the same, and a method thereof may be provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A storage device comprising:
a plurality of non-volatile memories; and
a storage controller connected to the plurality of non-volatile memories through a data line,
wherein the plurality of non-volatile memories are connected to each other through an internal clock line separated from the data line and an internal data line synchronized to the internal clock line, and
wherein each of the plurality of non-volatile memories is configured to transmit an internal data signal including prediction time information of a peak current through the internal data line.

2. The storage device of claim 1, wherein the internal data signal includes a header and a body, and
wherein, when the header indicates a first logical level, the body includes the prediction time information.

3. The storage device of claim 2, wherein, when the header indicates a second logical level, the body includes current amount information of the peak current.

4. The storage device of claim 1, wherein a non-volatile memory among the plurality of non-volatile memories is configured to transmit an internal clock signal through the internal clock line.

5. The storage device of claim 4, wherein the prediction time information indicates an occurrence prediction time of the peak current, the number of cycles of the internal clock signal, which remain from a transmission time of the internal data signal to the occurrence prediction time, or a residual time from the transmission time of the internal data signal to the occurrence prediction time.

6. The storage device of claim 1, wherein a non-volatile memory among the plurality of non-volatile memories is configured to transmit the internal data signal to remaining non-volatile memories in time intervals individually allocated to the non-volatile memory.

7. The storage device of claim 6, wherein, when the prediction time information is changed after the internal data signal is transmitted in a first time interval among the time intervals, the non-volatile memory is configured to transmit the internal data signal including the changed prediction time information in a second time interval following the first time interval from among the time intervals.

8. The storage device of claim 6, wherein the remaining non-volatile memories are configured to stop scheduled operations at an occurrence prediction time of the peak current indicated based on the prediction time information.

9. The storage device of claim 6, wherein the non-volatile memory is configured to:
transmit the internal data signal including the prediction time information, in a first time interval among the time intervals; and
transmit the internal data signal including current amount information of the peak current, in a second time interval following the first time interval from among the time intervals.

10. The storage device of claim 1, wherein a first non-volatile memory among the plurality of non-volatile memories is configured to:
buffer the prediction time information about the first non-volatile memory;
receive the internal data signal from a second non-volatile memory; and
when the prediction time information about the second non-volatile memory included in the internal data signal overlaps the buffered prediction time information, change the buffered prediction time information.

11. A method of a non-volatile memory, the method comprising:
obtaining an internal data signal including prediction time information of a peak current of the non-volatile memory; and
transmitting the internal data signal through an internal data line synchronized to an internal clock line.

12. The method of claim 11, wherein the internal data signal includes a header and a body,
wherein, when the header indicates a first logical level, the body includes the prediction time information, and
wherein, when the header indicates a second logical level, the body includes current amount information of the peak current.

13. The method of claim 11, further comprising:
transmitting an internal clock signal through the internal clock line.

14. The method of claim 11, wherein the transmitting of the internal data signal is repeatedly performed in time intervals individually allocated to the non-volatile memory.

15. The method of claim 11, further comprising:
after the internal data signal is transmitted, checking whether the prediction time information is changed; and
when the prediction time information is changed, transmitting the internal data signal including the changed prediction time information.

16. The method of claim 14, wherein the transmitting of the internal data signal further includes:
transmitting the internal data signal including the prediction time information, in a first time interval among the time intervals; and
transmitting the internal data signal including current amount information of the peak current, in a second time interval following the first time interval from among the time intervals.

17. The method of claim 11, further comprising:
buffering the prediction time information;
receiving the internal data signal through the internal data line;
checking whether the prediction time information included in the internal data signal overlaps the buffered prediction time information; and
when the prediction time information included in the internal data signal overlaps the buffered prediction time information, changing the buffered prediction time information.

18. A non-volatile memory comprising:
a memory cell array;
an input/output circuit connected to a data line transmitting write data or read data associated with the memory cell array, an internal clock line separated from the data line, and an internal data line synchronized to the internal clock line; and
a control logic circuit configured to transmit an internal data signal including prediction time information of a peak current through the internal data line, based on controlling the input/output circuit.

19. The non-volatile memory of claim 18, further comprising:
a clock generator configured to generate an internal clock signal to be transmitted through the internal clock line.

20. The non-volatile memory of claim 19, wherein the clock generator is configured to stop the generating of the internal clock signal, based on that the peak current is not predicted within a prediction window.
